(19) United States
(12) Patent Application Publication
(10) Pub. No.: US 2018/0159579 A1
(43) Pub. Date: Jun. 7, 2018

(54) Smartphone Case Assembly

(71) Applicant: Vince Muriel Garcia, Richmond Hill (CA)

(72) Inventor: Vince Muriel Garcia, Richmond Hill (CA)

(21) Appl. No.: 15/371,420

(22) Filed: Dec. 7, 2016

(51) Int. Cl. H04B 1/3888; A45C 11/00; A45F 5/00

(52) U.S. Cl. CPC H04B 1/3888; A45C 11/00; H04M 1/0202; A45C 2011/002; A45F 2005/008; A45F 5/00

(57) ABSTRACT

A smart phone case assembly for selectively attaching an electronic device to a limb includes a case. The case may contain an electronic device thereby facilitating the electronic device to be manipulated. A pair of first straps is provided. Each of the first straps is coupled to the case to retain the case on an arm. A pair of second straps is provided. Each of the second straps is coupled to the case to retain the case on a hand.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to case devices and more particularly pertains to a new case device for selectively attaching an electronic device to a limb.

### BRIEF SUMMARY OF THE INVENTION

An embodiment of the disclosure meets the needs presented above by generally comprising a case. The case may contain an electronic device thereby facilitating the electronic device to be manipulated. A pair of first straps is provided. Each of the first straps is coupled to the case to retain the case on an arm. A pair of second straps is provided. Each of the second straps is coupled to the case to retain the case on a hand.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a smart phone case assembly according to an embodiment of the disclosure.

FIG. 2 is a right side view of an embodiment of the disclosure.

FIG. 3 is a top view of an embodiment of the disclosure.

FIG. 4 is a front view of an embodiment of the disclosure.

FIG. 5 is a left side perspective in-use view of an embodiment of the disclosure.

FIG. 6 is a top perspective in-use view of an embodiment of the disclosure.

### DETAILED DESCRIPTION OF THE INVENTION

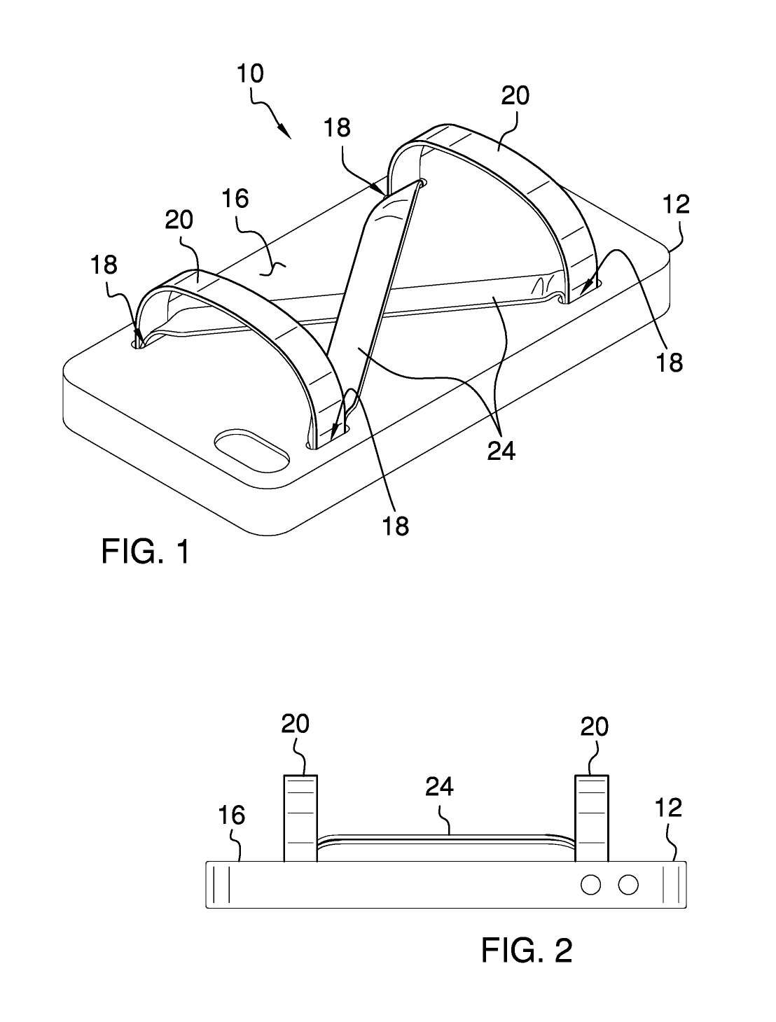

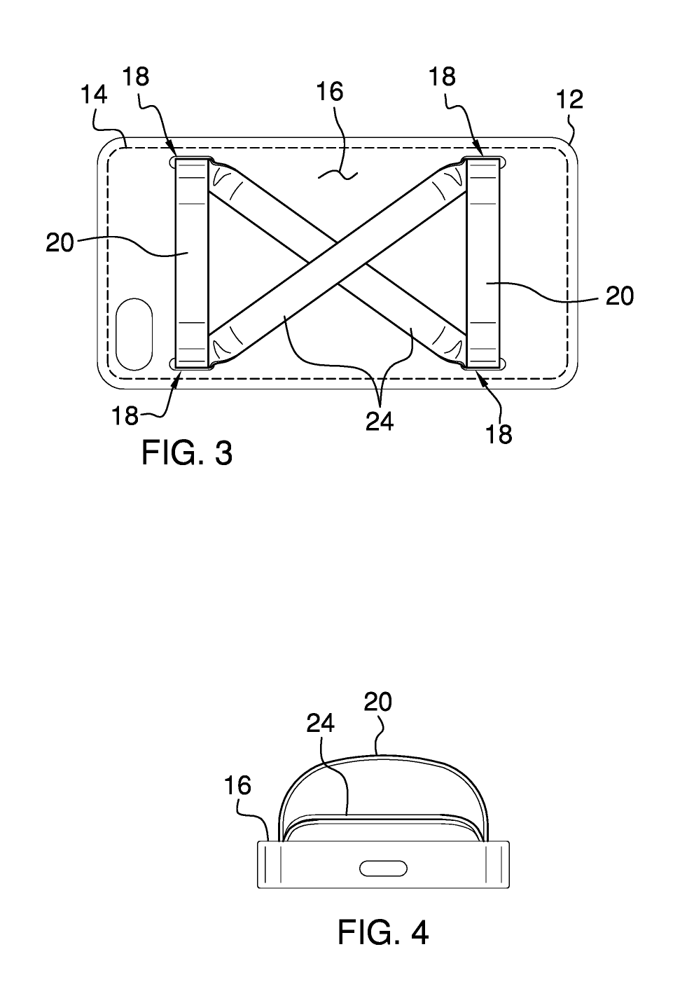

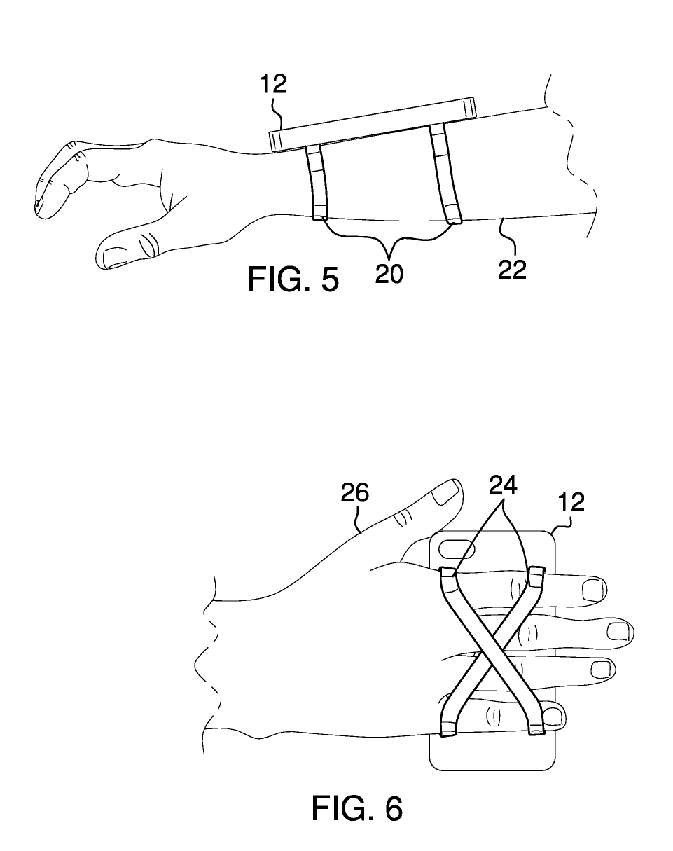

With reference now to the drawings, and in particular to FIGS. 1 through 6 thereof, a new case device embodying the principles and concepts of an embodiment of the disclosure and generally designated by the reference numeral 10 will be described.

As best illustrated in FIGS. 1 through 6, the smart phone case assembly 10 generally comprises a case 12. The case 12 may contain an electronic device 14 thereby facilitating the electronic device 14 to be manipulated. The electronic device 14 may be a smart phone or the like. The case 12 may be a smart phone case of any conventional design. The case 12 has a back surface 16. The back surface 16 has a plurality of wells 18 extending inwardly therein and the wells 18 are arranged to form four corners of a rectangle.

A pair of first straps 20 is provided and each of the first straps 20 is coupled to the case 12. Moreover, each of the first straps 20 may retain the case 12 on a forearm 22 of a user. Each of the first straps 20 is coupled between an associated pair of the wells 18. Each of the first straps 20 forms an arch with respect to the back surface 16. Thus, the arm may be extended between each of the first straps 20 and the back surface 16. The first straps 20 are spaced apart from each other. Each of the first straps 20 is comprised of a resiliently stretchable material.

A pair of second straps 24 is provided and each of the second straps 24 is coupled to the case 12. Each of the second straps 24 may retain the case 12 on a hand 26 of the user. Each of the second straps 24 is coupled between an associated pair of the wells 18. Thus, the hand 26 may be extended between each of the second straps 24 and the back surface 16. The second straps 24 are arranged to form an X. Thus, the second straps 24 retain the case 12 on the hand 26. Each of the second straps 24 is comprised of a resiliently stretchable material.

In use, the user's hand 26 is selectively extended between each of the second straps 24 and the back surface 16. Thus, the case 12 is retained on the user's hand 26. The case 12 is positioned such that the electronic device 14 is selectively manipulated. Moreover, the pair of second straps 24 inhibits the case 12 from being dropped. The user's forearm 22 is selectively extended between the second straps 24 and the back surface 16. Thus, the case 12 is retained on the user's forearm 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A smart phone case assembly being configured to be selectively coupled to a hand and an arm, said assembly comprising:
a case being configured to contain an electronic device thereby facilitating the electronic device to be manipulated, said case having a back surface, said back surface having a plurality of wells extending inwardly therein, each of said wells being inset from an outer perimeter of said back surface;
a pair of first straps, each of said first straps being coupled to said case wherein each of said first straps is configured retain said case on an arm, each of said first straps being coupled between an associated pair of said wells such that each of said first straps forms an arch with respect to said back surface wherein each of said first straps is configured to facilitate the arm to be extended between each of said first straps and said back surface, said pair of first straps being spaced apart from each other; and
a pair of second straps, each of said second straps being coupled to said case wherein each of said second straps is configured to retain said case on a hand.

2. The assembly according to claim 1, further comprising said wells being arranged to form four corners of a rectangle.

3. (canceled)

4. The assembly according to claim 2, wherein each of said second straps is coupled between an associated pair of said wells wherein each of said second straps is configured to have the hand extended between each of said second straps and said back surface, said second straps being arranged to form an X wherein said pair of second straps is configured to retain said case on the hand.

5. A smart phone case assembly being configured to be selectively coupled to a hand and an arm, said assembly comprising:
a case being configured to contain an electronic device thereby facilitating the electronic device to be manipulated, said case having a back surface, said back surface having a plurality of wells extending inwardly therein, each of said wells being inset from an outer perimeter of said back surface, said wells being arranged to form four corners of a rectangle;
a pair of first straps, each of said first straps being coupled to said case wherein each of said first straps is configured retain said case on an arm, each of said first straps being coupled between an associated pair of said wells such that each of said first straps forms an arch with respect to said back surface wherein each of said first straps is configured to facilitate the arm to be extended between each of said first straps and said back surface, said pair of first straps being spaced apart from each other; and
a pair of second straps, each of said second straps being coupled to said case wherein each of said second straps is configured to retain said case on a hand, each of said second straps being coupled between an associated pair of said wells wherein each of said second straps is configured to have the hand extended between each of said second straps and said back surface, said second straps being arranged to form an X wherein said pair of second straps is configured to retain said case on the hand.
